(19) United States
(12) Patent Application Publication
(10) Pub. No.: US 2026/0357628 A1
(43) Pub. Date: Nov. 12, 2026

(54) CHARGING PORT COVER ASSEMBLY AND VEHICLE WITH THE SAME

(71) Applicants: Hyundai Motor Company, Seoul (KR); Kia Corporation, Seoul (KR); KYUNGSHIN CO., LTD., Incheon-si (KR)

(72) Inventors: Je Hyun KIM, Hwaseong-Si (KR); Sam Gyun LEE, Hwaseong-Si (KR); Won Sup LEE, Incheon (KR)

(21) Appl. No.: 19/343,700

(22) Filed: Sep. 29, 2025

(30) Foreign Application Priority Data
May 8, 2025 (KR) 10-2025-0059751

(51) Int. Cl. E05F 1/12; B60L 53/16; E05C 3/00; E05C 3/14; H01R 13/447

(52) U.S. Cl. CPC E05F 1/1207; B60L 53/16; E05C 3/008; E05C 3/14; E05Y 2201/484; E05Y 2900/534; H01R 13/447; H01R 2201/26

(57) ABSTRACT

A charging port cover assembly is disclosed. The charging port cover assembly may include an attachment bracket for one or more charging ports. The attachment bracket may be affixed to a body of a vehicle and include a hinge support. The charging port cover assembly may further include one or more covers that are connected, via one or more first hinges, to the hinge support of the attachment bracket to be rotatable around a hinge axis of the one or more first hinges; and one or more latches configured to hold the one or more covers in a closed state. The one or more covers may include a hinge portion. A rib groove may be formed on the hinge portion. The hinge support may include a rib that is inserted into the rib groove to restrict movement, along a direction of the hinge axis, of the hinge portion.

### CROSS-REFERENCE TO REALTED APPLICATION

This application claims the benefit of and priority to Korean Patent Application No. 10-2025-0059751, filed in the Korean Intellectual Property Office on May 8, 2025, the entire content of which is hereby incorporated by reference for all purposes.

### TECHNICAL FIELD

The present disclosure relates to electric vehicles, and more specifically to a charging port cover assembly and a vehicle including the charging port cover assembly.

### BACKGROUND

An electric vehicle may be provided with an externally exposed charging port, to which a charging connector may be connected to charge a battery of the vehicle.

A vehicle may include two or more charging ports, for example, a slow-charging port and a fast-charging port, and a cover that covers the charging ports may include a slow-charging port cover and a fast-charging port cover.

The charging port cover may be vulnerable to the inflow of or contamination by foreign matter such as rainwater. Thus, there exists a need for an improved charging port cover.

The matters described in this Background section are only for enhancement of understanding of the background of the disclosure, and should not be taken as acknowledgement that they correspond to prior art already known to those skilled in the art.

### SUMMARY

The present disclosure is provided to solve at least one of the technical challenges described above.

An aspect of the present disclosure is to reduce movement along an axial direction of rotation at a hinge of a charging port cover, thereby reducing the entry of foreign matter by that movement.

Another aspect of the present disclosure is to enhance the sealing force of a charging port to its peripheral perimeter region.

Another aspect of the present disclosure is to partially overlap a slow-charging port cover and a fast-charging port cover, thereby reducing the entry of foreign matter through a gap between the covers.

Another aspect of the present disclosure is to provide the automatic opening of a charging cover based on a charger being detected, thereby improving user convenience.

According to one or more example embodiments of the present disclosure, a charging port cover assembly may include an attachment bracket for one or more charging ports. The attachment bracket may be configured to be affixed to a body of a vehicle and include a hinge support. The charging port cover assembly may further include one or more covers that are connected, via one or more first hinges, to the hinge support of the attachment bracket to be rotatable around a hinge axis of the one or more first hinges. Each of the one or more covers may be configured to cover or uncover a corresponding charging port of the one or more charging ports. The charging port cover assembly may further include one or more latches configured to hold the one or more covers in a closed state. The one or more covers may include a hinge portion. A rib groove may be formed on the hinge portion. The hinge support may include a rib that is inserted into the rib groove to restrict movement, along a direction of the hinge axis, of the hinge portion.

The hinge support may further include a pair of support walls that rotatably support both sides of the hinge portion. The rib may be positioned by being biased toward one support wall of the pair of support walls.

The hinge portion may include: two first diameter portions, and a second diameter portion that is disposed between the two first diameter portions. A first diameter of the two first diameter portions may be greater than a second diameter of the second diameter portion. The rib groove may be defined by an outer surface of the second diameter portion in a space between the two first diameter portions.

The hinge support may include a pair of support walls to which the hinge portion is connected. Movement, along the direction of the hinge axis, of a first one, of the two first diameter portions, may be restricted between a first support wall, of the pair of support walls, and the rib. Movement, along the direction of the hinge axis, of a second one, of the two first diameter portions, may be restricted between a second support wall, of the pair of support walls, and the rib.

The hinge portion may include: a bushing through which a hinge pin penetrates, and a spring configured to provide an elastic resilience to restore the one or more covers from the closed state to an open state.

The one or more latches may be connected, via a second hinge, to the attachment bracket and include a release portion. The charging port cover assembly may further include an actuator configured to release the one or more latches by pushing the release portion, of the one or more latches, to rotate the one or more latches around the second hinge.

The one or more charging ports may include a first charging port and a second charging port. The one or more latches may include a first latch and a second latch. The one or more covers may include: a first cover configured to cover or uncover the first charging port. The first latch may be configured to hold the first cover in the closed state. The one or more covers may further include a second cover configured to cover or uncover the second charging port. The second latch may be configured to hold the second cover in the closed state. The first cover and the second cover may include at least partially overlap along the direction of the hinge axis.

The first cover may include: a flange, and a cover rib extending from the flange along a second direction perpendicular to the direction of the hinge axis. The second cover may include: a first recess configured to be covered by the flange, and a second recess configured to face the cover rib in the second direction.

The attachment bracket may include: a first port groove in which the first charging port is placed, a second port groove in which the second charging port is placed, and a latch groove configured to receive a latch of a charging connector. The latch groove may include a flat surface including a peripheral perimeter region of the first port groove, a peripheral perimeter region of the second port groove, and a peripheral perimeter region of the latch groove. The first cover may include a first pad configured to abut the peripheral perimeter region of the first port groove and the peripheral perimeter region of the latch groove. The second cover may include a second pad configured to abut the peripheral perimeter region of the second port groove.

According to one or more example embodiments of the present disclosure, a vehicle may include an attachment bracket affixed to a body of the vehicle and supports a one or more charging ports. The attachment bracket may include a hinge support. The vehicle may further include one or more covers that are connected, via one or more first hinges, to the hinge support of the attachment bracket to be rotatable around a hinge axis of the one or more first hinges. Each of the one or more covers may be configured to cover or uncover a corresponding charging port of the one or more charging ports. The vehicle may further include one or more latches configured to hold the one or more covers in a closed state. The one or more covers may include a hinge portion. A rib groove may be formed on the hinge portion. The hinge support may include a rib that is inserted into the rib groove to restrict movement, along a direction of the hinge axis, of the hinge portion.

The hinge support may further include a pair of support walls that rotatably support both sides of the hinge portion. The rib may be is positioned by being biased toward one support wall of the pair of support walls.

The hinge portion may include: two first diameter portions, and a second diameter portion that is disposed between the two first diameter portions. A first diameter of the two first diameter portions may be greater than a second diameter of the second diameter portion. The rib groove may be defined by an outer surface of the second diameter portion in a space between the two first diameter portions.

The hinge support may include a pair of support walls to which the hinge portion is connected. Movement, along the direction of the hinge axis, of a first one, of the two first diameter portions, may be restricted between a first support wall, of the pair of support walls, and the rib. Movement, along the direction of the hinge axis, of a second one, of the two first diameter portions, may be restricted between a second support wall, of the pair of support walls, and the rib.

The hinge portion may include: a bushing through which a hinge pin penetrates, and a spring configured to provide an elastic resilience to restore the one or more covers from the closed state to an open state.

The one or more latches may be connected, via a second hinge, to the attachment bracket and include a release portion. The vehicle may further include an actuator configured to release the one or more latches by pushing the release portion, of the one or more latches, to rotate the one or more latches around the second hinge.

The vehicle may further include: a sensor configured to detect a charging plug; and a controller configured to control, based on the charging plug being detected by the sensor, the actuator.

The vehicle may further include: a rain sensor; and a controller configured to control, based on a signal from the rain sensor, the actuator.

The one or more charging ports may include a first charging port and a second charging port. The one or more latches may include a first latch and a second latch. The one or more covers may include a first cover configured to cover or uncover the first charging port. The first latch may be configured to hold the first cover in the closed state. The one or more covers may further include a second cover configured to cover or uncover the second charging port. The second latch may be configured to hold the second cover in the closed state. The first cover and the second cover may at least partially overlap along the direction of the hinge axis.

The first cover may include: a flange, and a cover rib extending from the flange along a second direction perpendicular to the direction of the hinge axis. The second cover may include: a first recess configured to be covered by the flange, and a second recess configured to face the cover rib in the second direction.

The attachment bracket may include: a first port groove in which the first charging port is placed, a second port groove in which the second charging port is placed, and a latch groove configured to receive a latch of a charging connector. The latch groove may include a flat surface including a peripheral perimeter region of the first port groove, a peripheral perimeter region of the second port groove, and a peripheral perimeter region of the latch groove. The first cover may include a first pad configured to abut the peripheral perimeter region of the first port groove and the peripheral perimeter region of the latch groove. The second cover may include a second pad configured to abut the peripheral perimeter region of the second port groove.

### BRIEF DESCRIPTION OF THE DRAWINGS

FIG. 1 illustrates an example charging port cover assembly of a vehicle.

FIG. 2 illustrates an example charging cover in an open state.

FIGS. 3 and 4 illustrate an example hinge connection structure of a first cover.

FIGS. 5 and 6 illustrate an example hinge connection structure of a second cover.

FIG. 7 illustrates an example scheme for automatic opening of a first cover based on a first latch being released.

FIG. 8 illustrates an example scheme for automatic opening of a second cover based on a second latch being released.

FIG. 9 illustrates an example automatic opening process of a first cover or a second cover.

FIG. 10 illustrates a cross-sectional view of a first cover and a second cover.

FIG. 11 illustrates a first pad and a second pad overlapping a perimeter region around a first port and a second port.

FIG. 12 shows an example computing system.

### DETAILED DESCRIPTION

Hereinafter, one or more example embodiments of the present disclosure will be described in detail with reference to the accompanying drawings. The example embodiment(s) are not construed as limited to the disclosure and should be understood to include all changes, equivalents, and replacements within the idea and technical scope of the disclosure.

The terms "module," "unit," and/or "-er/or" for referring to components are assigned and used interchangeably in consideration of the ease of explanation, and thus the terms per se do not necessarily have different meanings or functions. The terms "module," "unit," and/or "-er/or" are not necessarily construed as being physically or chemically separated or distinguished.

Although terms including ordinal numbers such as "first," "second," and the like may be used herein to describe various components, the components are not limited by these terms. These terms may be used only in a descriptive sense to distinguish one component from another, and the order among them is determined from the context of their descriptions, not from such notation.

The term "and/or" is used to include any combination of multiple items that are subject to it. For example, "A and/or B" may include all three cases, for example, "A," "B," and "A and B."

When a component is described as "coupled" or "connected" to another component, the component may be directly coupled or connected to the other component. However, it is to be understood that another component may be present therebetween. In contrast, when a component is described as "directly coupled" or "directly connected" to another component, it is to be understood that there are no other components therebetween.

The singular forms "a," "an," and "the" are intended to include the plural forms as well, unless the context clearly indicates otherwise. It is to be further understood that the terms "comprises/comprising" and/or "includes/including" used herein specify the presence of stated features, integers, steps, operations, elements, and/or components, but do not preclude the presence or addition of one or more other features, integers, steps, operations, elements, components and/or groups thereof.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In the following description and drawings, a first axial direction, a second axial direction, and a third axial direction are denoted as an x-axis direction, a y-axis direction, and a z-axis direction, respectively, and the first axial direction, the second axial direction, and the third axial direction may represent, with respect to a vehicle, a top-bottom direction, a side-to-side direction, and a front-to-back direction, respectively. However, they are provided only to facilitate the explanation, but the present disclosure is not limited to such directions.

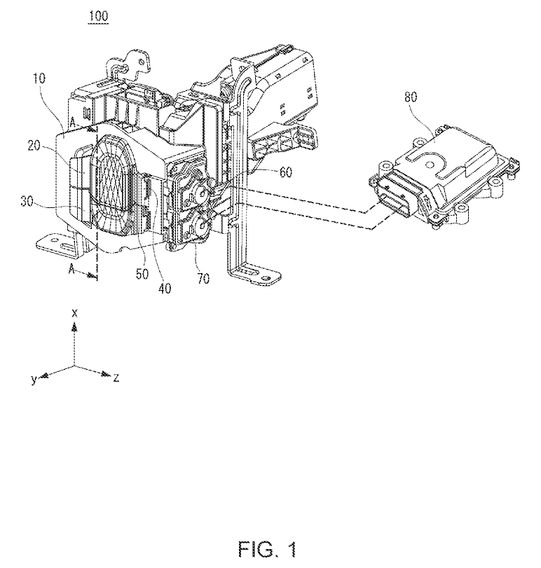

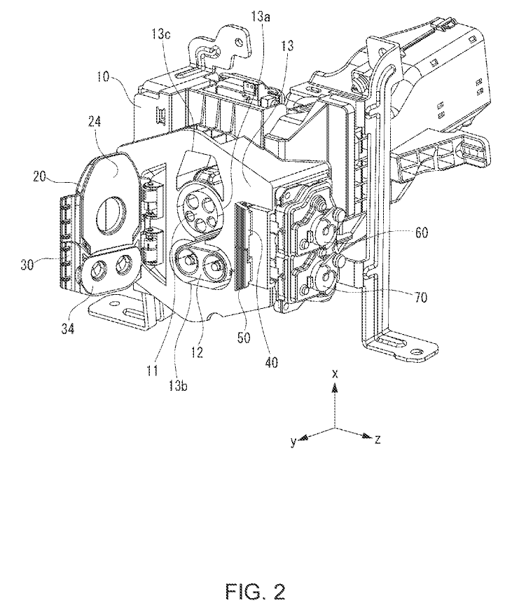

FIG. 1 illustrates an example charging port cover assembly of a vehicle. FIG. 2 illustrates an example charging cover in an open state. A vehicle 100 may include a charging port cover assembly and a charging controller 80.

The charging port cover assembly may include a retaining bracket (also referred to as a support bracket or an attachment bracket) 10 secured (e.g., affixed) to a body of the vehicle 100, one or more covers (e.g., a cover 20 and/or a cover 30), one or more latches (e.g., a latch 40 and/or a latch 50), etc.

The retaining bracket 10 may support one or more charging ports (e.g., 11 and/or 12). The one or more charging ports (also referred to as charge ports) 11 and/or 12 may be affixed to the retaining bracket 10. For example, the charging ports 11 and/or 12 may include a first port (also referred to as a first charging port) 11 and a second port (also referred to as a second charging port) 12.

The cover 20 and/or 30 may include a first cover 20 and a second cover 30 corresponding to the respective charging ports (e.g., the first cover 20 corresponding to the first charging port 11 and the second cover 30 corresponding to the second charging port 12. Each of the cover 20 and the cover 30 may be a door (e.g., a charge port door).

The first port 11 and the second port 12 may have different charging speeds, different form factors, different pinouts, different charging voltages, different charging current types (e.g., alternating current (AC), direct current (DC), etc.), different charging amperages, different charging standards, etc. For example, the first port 11 may be a slow-charging port, and the second port 12 may be a fast-charging port (e.g., the second port 12 having a faster charging speed than the first port 11). However, the present disclosure is not necessarily limited to this. For example, the first port 11 may have a faster charging speed than the second port 12. The first port 11 and/or the second port 12 may be, for example, a North American Charging Standard (NACS) port (also referred to as an SAE J3400 port), an SAE J1772 port, etc. The first port 11 and the second port 12 may be a combined charging port, such as a Combined Charging System Combo (CCS) 1 port, a CCS2 port, etc.

At slow charging, only the first cover 20 may be opened to insert a slow-charging connector into the first port 11 for the slow charging, and at fast charging, the second cover 30 may be opened together to insert a fast-charging connector into the first port 11 and the second port 12 for the fast charging.

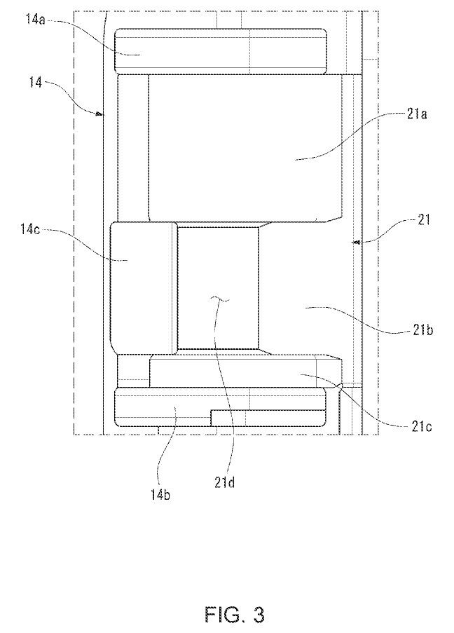

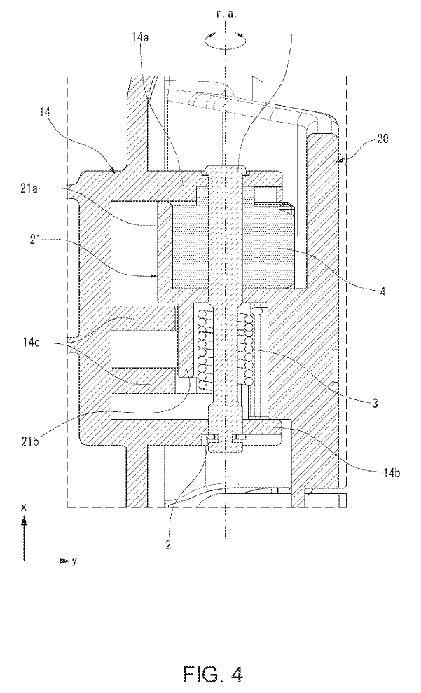

The first cover 20 and the second cover 30 may each be hingedly connected (e.g., connected via a hinge) to the retaining bracket 10. A hinge connection structure of the first cover 20 will be described first in more detail below with reference to FIGS. 3 and 4.

FIGS. 3 and 4 illustrate an example hinge connection structure of a first cover. The retaining bracket 10 may include a first hinge support 14, and the first cover 20 may include a first hinge portion 21 hingedly connected to the first hinge support 14.

The first hinge support 14 may include a first support wall 14a, a second support wall 14b, and one or more first ribs 14c disposed therebetween.

The first hinge portion 21 may include a first large diameter portion 21a and a second large diameter portion 21c, and a first small diameter portion 21b disposed between the first large diameter portion 21a and the second large diameter portion 21c. The first large diameter portion 21a and the second large diameter portion 21c may each have an outer diameter greater than that of the first small diameter portion 21b, but the first large diameter portion 21a and the second large diameter portion 21c may not necessarily have the same outer diameter.

The first hinge portion 21 may include a first rib groove 21d, and the first rib groove 21d may be defined by a space between the first large diameter portion 21a and the second large diameter portion 21c and an outer surface of the first small diameter portion 21b.

The first rib 14c may be disposed to be inserted into the first rib groove 21d, which may be disposed between the first support wall 14a and the second support wall 14b, biased toward the second support wall 14b, as shown in FIG. 3. In other words, the first rib 14c may be closer (e.g., in distance) to the second support wall 14b than it is to the first support wall 14a. However, the present disclosure is not necessarily limited to this.

The length of the first rib(s) 14c in the first axial direction may be determined to allow the first rib(s) 14c to be inserted, with a minimal gap, into the first rib groove 21d of the first hinge portion 21, such that a rotational motion of the first hinge portion 21 is not affected, with its movement in the first axial direction being restricted (e.g., minimized).

Further, the first large diameter portion 21a of the first hinge portion 21 may be disposed with a minimal gap between the first support wall 14a and the first rib(s) 14c, and the second large diameter portion 21c may be disposed with a minimal gap between the first rib(s) 14c and the second support wall 14b, whereby the movement of the first hinge portion 21 in the first axial direction may be further restricted (e.g., minimized).

Inside the first large diameter portion 21a of the first hinge portion 21, a first bush (e.g., bushing) 4 may be installed, as shown in FIG. 4. For this purpose, the first large diameter portion 21a may include a hollow bush groove open to one side in the first axial direction (an upper side as shown in FIG. 4).

The first bush 4 may be provided in the form of a cavity that allows a first hinge pin 1 to penetrate therethrough and may be inserted and disposed in the bush groove of the first large diameter portion 21a. The first bush 4 may provide a cushioning force against a rotational motion of the first cover 20 such that the first cover 20 is opened and closed smoothly and gently. The first bush 4 may be, for example, rubber, but is not necessarily limited thereto.

The first small diameter portion 21b of the first hinge portion 21 may include a hollow spring groove open to one side in the first axial direction (a lower side as shown in FIG. 4).

In the spring groove, a first torsion spring 3 may be installed, with one end of the first torsion spring 3 being supported by the first hinge portion 21 inside the spring groove and the other end being supported by the first hinge support 14.

The first torsion spring 3 may become load-free in a state where the first cover 20 is fully opened and, as the first cover 20 is closed, may be gradually twisted, providing a resilient force (e.g., elastic resilience, torsion force, etc.) to open the first cover 20 from a state where the first cover 20 is fully closed. The torsion spring 3 may provide torsion force

The first hinge portion 21 and the first hinge support 14 may be connected as described below. The first hinge portion 21 may be first positioned between the first support wall 14a and the second support wall 14b of the first hinge support 14, and then the first hinge pin 1 may be inserted into the second support wall 14b from the first support wall 14a through the first hinge portion 21, and then a first snap ring 2 may be fastened to the first hinge pin 1. Here, since the first hinge pin 1 has its head outer diameter larger than a corresponding through-hole in the first support wall 14a and the first snap ring 2 has an outer diameter larger than a corresponding through-hole in the second support wall 14b, a departure in the first axial direction may be prevented.

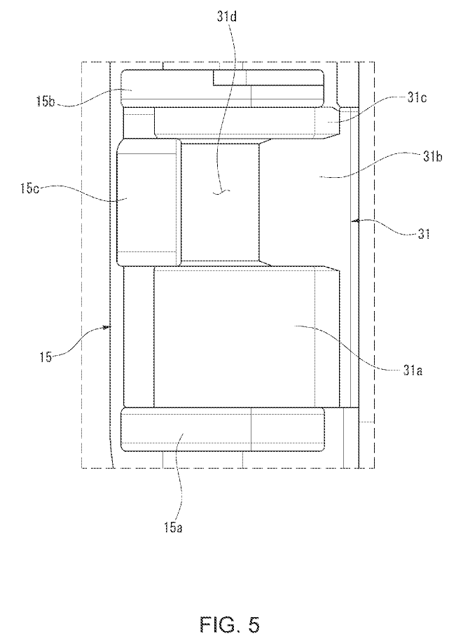

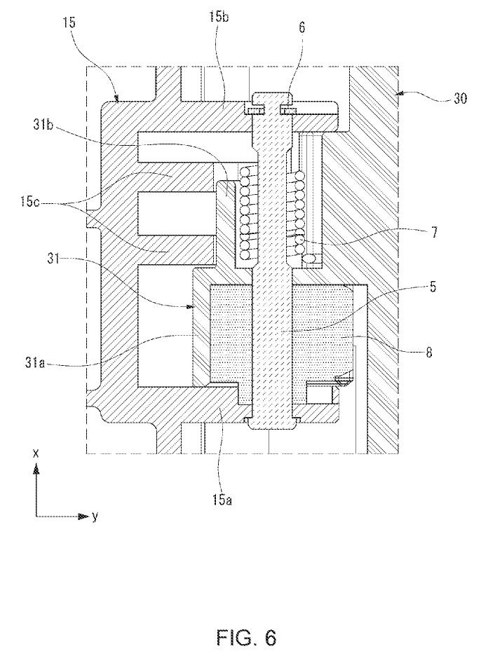

FIGS. 5 and 6 illustrate an example hinge connection structure of the second cover 30, which will be described in more detail below.

As learned by comparing FIGS. 3 and 5 or FIGS. 4 and 6, the hinge connection structure of the second cover 30 may be symmetrical about a second axis to the hinge connection structure of the first cover 20.

Referring to FIGS. 5 and 6, the retaining bracket 10 may include a second hinge support 15, and the second cover 30 may include a second hinge portion 31 hingedly connected (e.g., connected via a hinge) to the second hinge support 15.

The second hinge support 15 may include a third support wall 15a and a fourth support wall 15b, and a second rib 15c disposed therebetween.

The second hinge portion 31 may include a third large diameter portion 31a and a fourth large diameter portion 31c, and a second small diameter portion 31b disposed between the third large diameter portion 31a and the fourth large diameter portion 31c. The third large diameter portion 31a and the fourth large diameter portion 31c have an outer diameter larger than that of the second small diameter portion 31b, but the third large diameter portion 31a and the fourth large diameter portion 31c may not necessarily have the same outer diameter.

The second hinge portion 31 may include a second rib groove 31d, and the second rib groove 31d may be defined by a space between the third large diameter portion 31a and the fourth large diameter portion 31c and an outer surface of the second small diameter portion 31b.

The second rib 15c may be disposed to be inserted into the second rib groove 31d, which may be positioned between the third support wall 15a and the fourth support wall 15b, biased toward the fourth support wall 15b, as shown in FIG. 5. However, the present disclosure is not necessarily limited to this.

As with the first rib(s) 14c, the length of the second rib 15c in the first axial direction may be determined to allow the second rib 15c to be inserted, with a minimal gap, into the second rib groove 31d of the second hinge portion 31, such that a rotational motion of the second hinge portion 31 is not affected, with its movement in the first axial direction being restricted (e.g., minimized).

Further, the third large diameter portion 31a of the second hinge portion 31 may be disposed with a minimal gap between the third support wall 15a and the second rib 15c, and the fourth large diameter portion 31c may be disposed with a minimal gap between the second rib 15c and the fourth support wall 15b, whereby the movement of the second hinge portion 31 in the first axial direction may be further restricted (e.g., minimized).

Inside the third large diameter portion 31a of the second hinge portion 31, a second bush 8 may be installed, as shown in FIG. 6. For this purpose, the third large diameter portion 31a may include a hollow bush groove open to one side in the first axial direction (a lower side as shown in FIG. 6).

The second bush 8 may be provided in the form of a cavity that allows a second hinge pin 5 to penetrate therethrough and may be inserted and disposed in the bush groove of the third large diameter portion 31a. The second bush 8 may provide a cushioning force against a rotational motion of the second cover 30 such that the second cover 30 is opened and closed smoothly and gently.

The second small diameter portion 31b of the second hinge portion 31 may include a hollow spring groove open to one side in the first axial direction (a lower side as shown in FIG. 6).

In the spring groove, a second torsion spring 7 may be installed, with one end of the second torsion spring 7 being supported by the second hinge portion 31 inside the spring groove and the other end being supported by the second hinge support 15.

The second torsion spring 7 may become load-free in a state where the second cover 30 is fully opened and, as the second cover 30 is closed, may be gradually twisted, providing a resilient force to open the second cover 30 from a state where the second cover 30 is fully closed.

The second hinge portion 31 and the second hinge support 15 may be connected as described below. The second hinge portion 31 may first be positioned between the third support wall 15a and the fourth support wall 15b of the second hinge support 15, and then the second hinge pin 5 may be inserted into the fourth support wall 15b from the third support wall 15a through the second hinge portion 31, and then a second snap ring 6 may be fastened to the second hinge pin 5. Here, since the second hinge pin 5 has its head outer diameter larger than a corresponding through-hole in the third support wall 15a and the second snap ring 6 has an outer diameter larger than a corresponding through-hole in the fourth support wall 15b, a departure in the first axial direction may be prevented.

On the other hand, the latch 40 and/or 50 may be installed on the retaining bracket 10 and may include a first latch 40 that hooks an end of the first cover 20 to maintain (e.g., hold) it in a closed state and a second latch 50 that hooks an end of the second cover 30 to maintain it in a closed state.

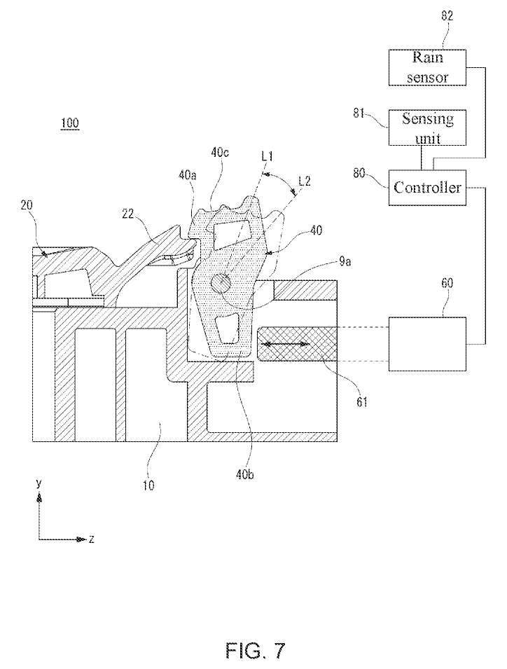

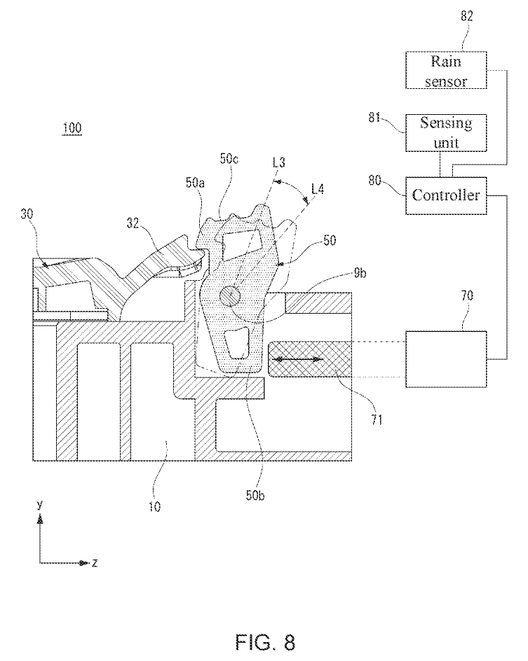

The structures and operations of the first latch 40 and the second latch 50 will be described in more detail below with reference to FIGS. 7 and 8.

FIG. 7 illustrates an example scheme for automatic opening of a first cover based on a first latch being released. The first latch 40 may be rotatably, hingedly connected (e.g., connected via a hinge, such as a latch hinge) to the retaining bracket 10 through a third hinge pin 9a, as shown in FIG. 7.

The first latch 40 may include a first hook 40a to hook a first hanging portion 22 of the first cover 20 and include a first release portion 40b opposite the first hook 40a relative to the third hinge pin 9a.

The first latch 40 may also include a first pressing portion 40c for a user to press by hand to release the first hook 40a from the first hanging portion 22.

As the first latch 40 is rotated, it may be repositioned between a first location L1 and a second location L2, and the first hanging portion 22 may be hung to the first hook 40a at the first location L1 and be released therefrom at the second location L2.

Although not shown, a torsion spring may be installed to provide the first latch 40 with a resilient force that restores it from the second location L2 to the first location L1.

The first cover 20 may be automatically opened by the resilient force of the first torsion spring 3 when the user presses the first pressing portion 40c to release the first hanging portion 22 being hung to the first hook 40a therefrom, and the first pressing portion 40c may be restored to the first location L1 when the user releases the first pressing portion 40c.

For the automatic opening of the first cover 20, a first actuator 60 that pushes the first release portion 40b to reposition the first latch 40 to the second location L2 may be further included.

The first actuator 60 may include a motor and a motion converter to convert rotation of the motor into linear motion, and a first actuating rod 61 that moves linearly by the motion converter.

Referring to FIG. 7, the first latch 40 may be rotated from the first location L1 to the second location L2 as the first release portion 40b moves forward by forward movement of the first actuating rod 61, which may allow the release of the first cover 20.

The motion converter that converts rotation into linear motion may be implemented by inclusion of at least one of a cam, a ball screw, and a link mechanism, for example. It will also be appreciated that the first actuator 60 itself may be a linear motor or a solenoid-type actuator. However, the present disclosure is not limited to any of these examples.

The first actuator 60 may be controlled by the charging controller 80 in the vehicle 100, and the charging controller 80 may perform the control based on sensing results by a sensing unit (also referred to as a sensor) 81 and/or a rain sensor (also referred to as a rain sensor) 82.

The sensing unit 81 may sense or detect the approach of a slow charger or a fast charger at a charging station. The sensing unit 81 may be, for example, a proximity sensor, a magnetic sensor, a Near-Field Communication (NFC) receiver, a Bluetooth receiver, etc. The sensing unit 81 may be configured to detect that a charger (e.g., charging connector or charging plug) is within a threshold distance from the charging port (e.g., the charging port 11 and/or the charging port 12).

Based on a slow charger being sensed by the sensing unit 81, the charging controller 80 may transmit a control command to the first actuator 60 to advance the first actuating rod 61, and the first actuator 60 may execute the corresponding operation accordingly.

The sensing unit 81 may wirelessly communicate with a slow charger or fast charger, and may sense their approach accordingly, and may include, for example, a low frequency (LF) antenna installed on a door handle or trunk door of the vehicle 100, and may also include a body controller that receives signals from the LF antenna and transmits predetermined control commands to related components. Here, a method of communication is not limited to using the LF antenna, and other methods than the one using the LF antenna, for example, ultra-wideband (UWB), Bluetooth low energy (BLE), near-field communication (NFC), and radio frequency (RF), may be used.

The sensing unit 81 may wirelessly recognize the approach of a driver, and the charging controller 80 may accordingly control the first actuator 60 and/or the second actuator 70 for automatic opening of the first cover 20 and/or the second cover 30. For example, to sense the approach of the driver, wireless communication between a smart key (or fob key) or smartphone carried by the driver and a vehicle may be utilized. For example, the sensing unit 81 of the vehicle may detect the approach of the smart key (or fob key) or smartphone via wireless communication technologies such as LF communication, UWB, BLE, NFC, and RF communication.

In addition, based on a determination that it is raining as sensed by the rain sensor 82 installed in the vehicle 100, the charging controller 80 may stop the automatic opening function to block rainwater despite a charger being detected.

FIG. 8 illustrates the second latch 50, which will be described below.

As shown in FIG. 8, the second latch 50 may be rotatably, hingedly connected to the retaining bracket 10 through a fourth hinge pin 9b.

The second latch 50 may include a second hook 50a to hook the second hanging portion 32 of the second cover 30, and a second release portion 50b opposite the second hook 50a relative to the fourth hinge pin 9b.

The second latch 50 may also include a second pressing portion 50c for a user to press by hand to release the second hook 50a from the second hanging portion 32.

As the second latch 50 is rotated, it may be repositioned between a third location L3 and a fourth location L4, and the second hanging portion 32 may be hung to the second hook 50a at the third location L3 and be released therefrom at the fourth location L4.

Similarly, although not shown, a torsion spring may be installed to provide the second latch 50 with a resilient force that restores it from the fourth location L4 to the third location L3.

The second cover 30 may be automatically opened by the resilient force of the second torsion spring 7 when the user presses the second pressing portion 50c to release the second hanging portion 32 being hung to the second hook 50a therefrom, and the second pressing portion 50c may be restored to the third location L3 when the user releases the second pressing portion 50c.

For the automatic opening of the second cover 30, a second actuator 70 that pushes the second release portion 50b to reposition the second latch 50 to the fourth location L4 may be further included.

The second actuator 70 may also include a motor and a motion converter to convert rotation of the motor into linear motion, and a second actuating rod 71 that moves linearly by the motion converter.

Referring to FIG. 8, the second latch 50 may be rotated from the third location L3 to the fourth location L4 as the second release portion 50b moves forward by forward movement of the second actuating rod 71, which may allow the release of the second cover 30.

As with the first actuator 60, the motion converter that converts rotation into linear motion may be implemented by inclusion of at least one of a cam, a ball screw, and a link mechanism, for example. It will also be appreciated that the second actuator 70 itself may be a linear motor or a solenoid-type actuator. However, the present disclosure is not limited to any of these examples.

The second actuator 70 may also be controlled by the charging controller 80 in the vehicle 100, and the charging controller 80 may perform the control based on sensing results by the sensing unit 81 or the rain sensor 82.

Based on a fast charger being sensed by the sensing unit 81, the charging controller 80 may transmit a control command to the first actuator 60 to advance the first actuating rod 61 and a control command to the second actuator 70 to advance the second actuating rod 71.

Also, in this example, based on a determination that it is raining as sensed by the rain sensor 82 installed in the vehicle 100, the charging controller 80 may stop the automatic opening function by the first actuator 60 and the second actuator 70 to block rainwater despite a fast charger being detected.

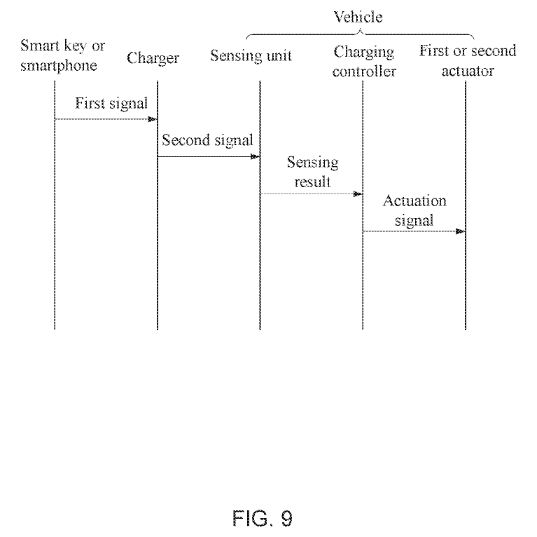

FIG. 9 illustrates an example automatic opening process of a first cover or a second cover. In particular, FIG. 9 illustrates an example control process for the automatic opening function of the first latch 40 and/or the second latch 50, which will be described in detail below.

First, when a user arrives at a charging station, stops their vehicle (e.g., the vehicle 100) near a charger, and tags a smart key (or fob key) or smartphone to the charger, a predetermined signal (first signal) may be transmitted to the charger through short-range wireless communication. The first signal may include predetermined authentication information.

Next, when the user performs a predetermined operation on the charger, the charger may transmit a second signal through short-range wireless communication to the vehicle 100. For example, when the user performs, on a body of the charger, a predetermined operation associated with, for example, a charge amount, payment method, or the like, the body of the charger may wirelessly transmit the second signal to the vehicle 100. The charger may include a charging connector, and the second signal may also be transmitted from the charging connector.

Based on the second signal being sensed, the sensing unit 81, i.e., a body controller, may transmit an open command for the first cover 20 and/or the second cover 30 to the charging controller 80.

The second signal may include information about the type of charging, for example, whether it is slow charging or fast charging, and depending on this information, an open command for the first cover 20 may be transmitted or an open command for both the first cover 20 and the second cover 30 may be transmitted.

The second signal may also include authentication information that is included in the first signal, and the body controller may transmit such an open command in response to a successful authentication based on the authentication information.

Based on the open command being received, the charging controller 80 may transmit an actuation signal to the first actuator 60 and/or the second actuator 70 accordingly.

The short-range wireless communication for transmitting the first signal may be, as a non-limiting example, NFC, and the short-range wireless communication for transmitting the second signal may be, as a non-limiting example, LF communication, but examples of which are not necessarily limited thereto and do not exclude other communication technologies such as Bluetooth, radio-frequency identification (RFID), Wi-Fi, or the like.

The charging controller 80 and the body controller may be included separately, but may also be integrated into a single controller.

A controller described herein may include a communication device that communicates with other controllers or sensors, a computer-readable recording medium that stores operating system (OS) or logic instructions, input/output information, or the like, and one or more processors that perform determinations, computations, decisions, or the like necessary to control the functions for which it is responsible.

Further, a processor described herein may include semiconductor integrated circuits and/or electronic devices that perform one or more of the comparisons, determinations, calculations, and decisions to achieve the programmed functions. For example, the processor may be any one or a combination of a computer, microprocessor, central processing unit (CPU), application-specific integrated circuit (ASIC), electronic circuitry, logic circuits, or the like.

Furthermore, a computer-readable recording medium (or simply referred to as memory) described herein may include any type of storage device that stores data that can be read by a computer system. For example, it may include at least one of memory of a flash memory type, hard disk type, micro type, and card type (e.g., secure digital (SD) card or extreme digital (XD) card), and memory of a random-access memory (RAM), static RAM (SRAM), read-only memory (ROM), programmable ROM (PROM), electrically erasable PROM (EEPROM), magnetic RAM (MRAM), magnetic disk, and optical disk type.

This recording medium may be electrically connected to a processor, and the processor may be configured to read data from the recording medium and write it in the recording medium. The recording medium and the processor may be integral, or may be physically separate.

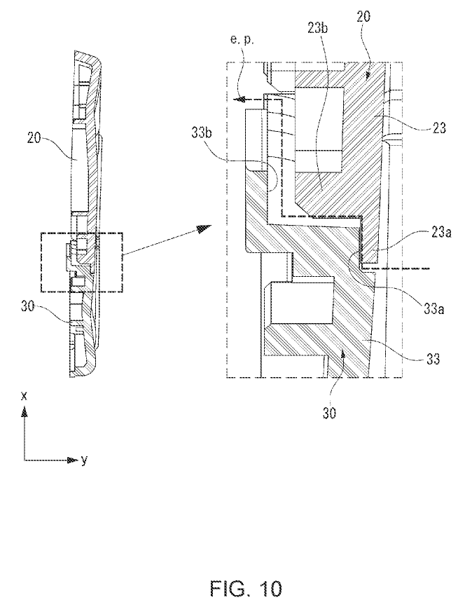

Furthermore, the first cover 20 and the second cover 30 may partially overlap to reduce or prevent (e.g., minimize) the entry of foreign matter such as rainwater, which will be described in more detail below with reference to FIG. 10.

FIG. 10 illustrates a cross-section A-A of FIG. 1, as shown with an overlapping structure where a bottom portion of the first cover 20 is disposed on a top portion of the second cover 30.

To this end, the first cover 20 may include a flange 23a at its lower end and a cover rib 23b extending along the second axial direction from an inner surface of the flange 23a.

The second cover 30 may include a first recess 33a into which the flange 23a of the first cover 20 is seated, and a second recess 33b opposite the cover rib 23b at a location spaced apart from the first recess 33a in the second axial direction.

This overlapping structure may make it difficult for foreign matter to enter by bending an entry path (e.p.) of foreign matter four times to complicate the entry path as shown in FIG. 10.

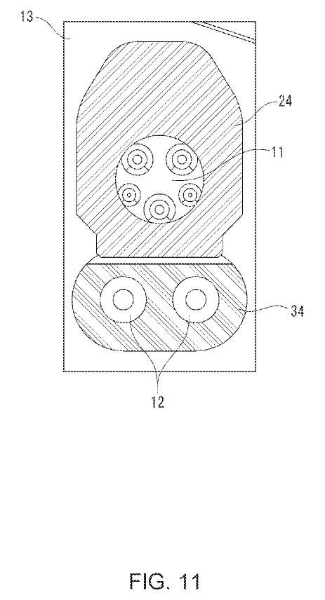

On the other hand, to further ensure that foreign matter be blocked from entering the first port 11 and the second port 12, a first pad 24 may be attached to the inner surface of the first cover 20 and a second pad 34 may be attached to the inner surface of the second cover 30, which will be described below with reference to FIG. 11.

As shown in FIG. 2, a first port groove 13a that receives the first port 11, a second port groove 13b that receives the second port 12, and a latch groove 13c into which the latch 40 or 50 of the charging connector is inserted may be formed on a first surface of the retaining bracket 10. In addition, the respective peripheral perimeter regions around the first port groove 13a, the second port groove 13b, and the latch groove 13c may be formed flat.

The first pad 24 may be attached to the inner surface of the first cover 20 such that it abuts the peripheral perimeter regions of the first port groove 13a and the latch groove 13c, and the second pad 34 may be attached to the inner surface of the second cover 30 such that it abuts the peripheral perimeter region of the second port groove 13b.

FIG. 11 illustrates a first pad and a second pad overlapping a perimeter region around a first port and a second port. In a state where the first cover 20 is closed, the first pad 24 may surround terminals of the first port 11 and seal their peripheral regions, and in a state where the second cover 30 is closed, the second pad 34 may surround terminals of the second port 12 and seal their peripheral regions, which may enhance a sealing force for blocking foreign matter.

The perimeter regions of the first port groove 13a, the latch groove 13c, and the second port groove 13b may be relatively wide and flat, which may contribute to enhancing the sealing force of the first pad 24 and the second pad 34.

The first pad 24 and the second pad 34 may be formed with a material such as, for example, any one of rubber, silicone, and sponge, but examples of the material are not limited thereto.

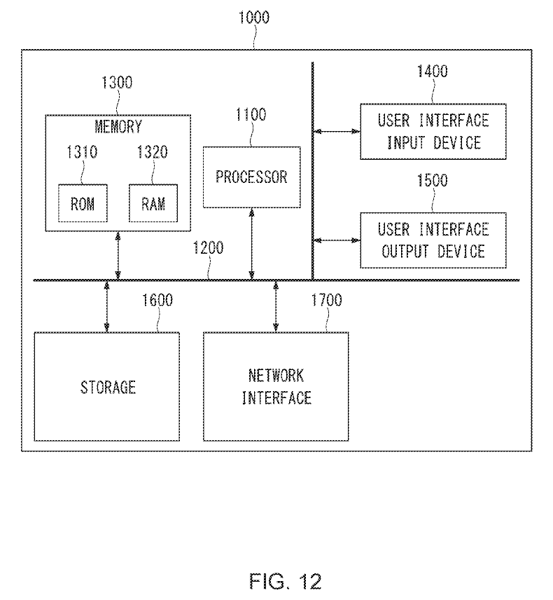

FIG. 12 shows an example computing system (e.g., a computing device of a vehicle or any other apparatus). One or more controllers, processors, etc. described herein may be implemented by the computing system or may be implemented in the computing system. For example, one or more of: the controller 80 as shown in FIG. 8, the smart key as shown in FIG. 9, the smartphone as shown in FIG. 9, the charger as shown in FIG. 9, the charging controller as shown in FIG. 9, etc. and any other devices or components disclosed herein may be implemented with the example computing system of FIG. 12.

A computing system (also referred as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to the present disclosure, there is provided a charging port cover assembly including a retaining bracket secured to a body of a vehicle and supports a charging port, a cover hingedly connected to the retaining bracket to rotate about a first axial direction and configured to open and close the charging port, and a latch configured to maintain the cover in a releasably closed state, wherein the cover comprises a hinge portion with a rib groove formed, and the retaining bracket comprises a hinge support to which the hinge portion is hingedly connected, wherein the hinge support comprises a rib that is inserted into the rib groove to limit movement of the hinge portion along the first axial direction.

The hinge support may comprise a pair of support walls that rotatably support both sides of the hinge portion, and the rib may be positioned by being eccentric to one side between the pair of support walls.

The hinge portion may comprise two large diameter portions and a small diameter portion disposed between the two large diameter portions, and the rib groove may be defined by an outer surface of the small diameter portion in a space between the two large diameter portions.

The hinge support may comprise a pair of support walls to which the hinge portion is hingedly connected, wherein one of the two large diameter portions may be limited to move along the first axial direction between one of the pair of support walls and the rib, and the other of the two large diameter portions may be limited to move along the first axial direction between the other of the pair of support walls and the rib.

The hinge may include a bush through which a hinge pin penetrates and a spring configured to provide an elastic resilience to restore the cover from the closed state to an open state.

The latch may be hingedly connected to the retaining bracket and comprises a release portion, and the charging port cover assembly may further include an actuator configured to release the latch by pushing the release portion to rotate the latch.

The charging port may include a first port and a second port, the latch may comprise a first latch and a second latch, and the cover may comprise a first cover configured to open and close the first port and to be maintained closed by the first latch and a second cover configured to open and close the second port and to be maintained closed by the second latch, wherein the first cover and the second cover at least partially overlap along the first axial direction.

The first cover may include a flange and a cover rib extending from the flange along a second axial direction perpendicular to the first axial direction, and the second cover may include a first recess configured to be covered by the flange and a second recess configured to face the cover rib in the second axial direction.

The retaining bracket may comprise a first port groove in which the first port is placed, a second port groove in which the second port is placed, and a latch groove into which a latch of a charging connector is inserted, and may comprise a flat surface formed as respective peripheral perimeter regions of the first port groove, the second port groove, and the latch groove, wherein the first cover may include a first pad configured to abut the peripheral perimeter regions of the first port groove and the latch groove, and the second cover may include a second pad configured to abut the peripheral perimeter region of the second port groove.

According to the present disclosure, there is provided a vehicle including a retaining bracket secured to a body of the vehicle and supports a charging port, a cover hingedly connected to the retaining bracket to rotate about a first axial direction and configured to open and close the charging port, and a latch configured to maintain the cover in a releasably closed state, wherein the cover comprises a hinge portion with a rib groove formed, and the retaining bracket comprises a hinge support to which the hinge portion is hingedly connected, wherein the hinge support comprises a rib that is inserted into the rib groove to limit movement of the hinge portion along the first axial direction.

The hinge support may include a pair of support walls that rotatably support both sides of the hinge portion, wherein the rib is positioned by being eccentric to one side between the pair of support walls.

The hinge may include two large diameter portions and a small diameter portion disposed between the two large diameter portions, wherein the rib groove is defined by an outer surface of the small diameter portion in a space between the two large diameter portions.

The hinge support may include a pair of support walls to which the hinge portion is hingedly connected, wherein one of the two large diameter portions is limited to move along the first axial direction between one of the pair of support walls and the rib, and the other of the two large diameter portions is limited to move along the first axial direction between the other of the pair of support walls and the rib.

The hinge may include a bush through which a hinge pin penetrates and a spring configured to provide an elastic resilience to restore the cover from the closed state to an open state.

The latch may be hingedly connected to the retaining bracket and comprise a release portion, and the charging port cover assembly may further comprise an actuator configured to release the latch by pushing the release portion to rotate the latch.

The vehicle may further include a sensing unit configured to sense a charger, and a controller configured to control the actuator based on the charger being sensed.

The vehicle may further include a rain sensor, wherein the controller is configured to control the actuator based on a signal from the rain sensor.

The charging port may include a first port and a second port, the latch may comprise a first latch and a second latch, and the cover may comprise a first cover configured to open and close the first port and to be maintained closed by the first latch and a second cover configured to open and close the second port and to be maintained closed by the second latch, wherein the first cover and the second cover at least partially overlap along the first axial direction.

The first cover may include a flange and a cover rib extending from the flange along a second axial direction perpendicular to the first axial direction, and the second cover may comprise a first recess configured to be covered by the flange and a second recess configured to face the cover rib in the second axial direction.

The retaining bracket may include a first port groove in which the first port is placed, a second port groove in which the second port is placed, and a latch groove into which a latch of a charging connector is inserted, and may comprise a flat surface formed as respective peripheral perimeter regions of the first port groove, the second port groove, and the latch groove, wherein the first cover includes a first pad configured to abut the peripheral perimeter regions of the first port groove and the latch groove, and the second cover includes a second pad configured to abut the peripheral perimeter region of the second port groove.

According to the present disclosure, movement along an axial direction of rotation at a hinge of a charging port cover may be reduced, and the entry of foreign matter by that movement may thus be reduced.

According to the present disclosure, a sealing force of a charging port to its peripheral perimeter region may be enhanced, and the entry of foreign matter into the charging port may thus be reduced.

According to the present disclosure, a potential entry of foreign matter through a gap between a slow-charging port cover and a fast-charging port cover may be reduced.

According to the present disclosure, the automatic opening of a charging cover may be provided based on a charger being detected, improving user convenience.

What is claimed is:

1. A charging port cover assembly comprising:
an attachment bracket for one or more charging ports, wherein the attachment bracket is configured to be affixed to a body of a vehicle and comprises a hinge support;
one or more covers connected, via one or more first hinges, to the hinge support of the attachment bracket to be rotatable around a hinge axis of the one or more first hinges, wherein each of the one or more covers is configured to cover or uncover a corresponding charging port of the one or more charging ports; and
one or more latches configured to hold the one or more covers in a closed state,
wherein the one or more covers comprise a hinge portion, wherein a rib groove is formed on the hinge portion, and
wherein the hinge support comprises a rib that is inserted into the rib groove to restrict movement, along a direction of the hinge axis, of the hinge portion.

2. The charging port cover assembly of claim 1, wherein the hinge support further comprises a pair of support walls that rotatably support both sides of the hinge portion, and
wherein the rib is positioned by being biased toward one support wall of the pair of support walls.

3. The charging port cover assembly of claim 1, wherein the hinge portion comprises:
two first diameter portions, and
a second diameter portion that is disposed between the two first diameter portions,
wherein a first diameter of the two first diameter portions is greater than a second diameter of the second diameter portion, and
wherein the rib groove is defined by an outer surface of the second diameter portion in a space between the two first diameter portions.

4. The charging port cover assembly of claim 3, wherein the hinge support comprises a pair of support walls to which the hinge portion is connected,
wherein movement, along the direction of the hinge axis, of a first one, of the two first diameter portions, is restricted between a first support wall, of the pair of support walls, and the rib, and
wherein movement, along the direction of the hinge axis, of a second one, of the two first diameter portions, is restricted between a second support wall, of the pair of support walls, and the rib.

5. The charging port cover assembly of claim 1, wherein the hinge portion comprises:
a bushing through which a hinge pin penetrates, and
a spring configured to provide an elastic resilience to restore the one or more covers from the closed state to an open state.

6. The charging port cover assembly of claim 1, wherein the one or more latches are connected, via a second hinge, to the attachment bracket and comprises a release portion, and
wherein the charging port cover assembly further comprises an actuator configured to release the one or more latches by pushing the release portion, of the one or more latches, to rotate the one or more latches around the second hinge.

7. The charging port cover assembly of claim 1, wherein the one or more charging ports comprise a first charging port and a second charging port,
wherein the one or more latches comprise a first latch and a second latch, and
wherein the one or more covers comprise:
a first cover configured to cover or uncover the first charging port, wherein the first latch is configured to hold the first cover in the closed state, and
a second cover configured to cover or uncover the second charging port, wherein the second latch is configured to hold the second cover in the closed state, and
wherein the first cover and the second cover at least partially overlap along the direction of the hinge axis.

8. The charging port cover assembly of claim 7, wherein the first cover comprises:
a flange, and
a cover rib extending from the flange along a second direction perpendicular to the direction of the hinge axis, and
wherein the second cover comprises:
a first recess configured to be covered by the flange, and
a second recess configured to face the cover rib in the second direction.

9. The charging port cover assembly of claim 7, wherein the attachment bracket comprises:
a first port groove in which the first charging port is placed,
a second port groove in which the second charging port is placed, and
a latch groove configured to receive a latch of a charging connector, wherein the latch groove comprises a flat surface comprising a peripheral perimeter region of the first port groove, a peripheral perimeter region of the second port groove, and a peripheral perimeter region of the latch groove,
wherein the first cover comprises a first pad configured to abut the peripheral perimeter region of the first port groove and the peripheral perimeter region of the latch groove, and
wherein the second cover comprises a second pad configured to abut the peripheral perimeter region of the second port groove.

10. A vehicle comprising:
an attachment bracket affixed to a body of the vehicle and supports a one or more charging ports, wherein the attachment bracket comprises a hinge support;
one or more covers connected, via one or more first hinges, to the hinge support of the attachment bracket to be rotatable around a hinge axis of the one or more first hinges, wherein each of the one or more covers is configured to cover or uncover a corresponding charging port of the one or more charging ports; and
one or more latches configured to hold the one or more covers in a closed state,
wherein the one or more covers comprise a hinge portion, wherein a rib groove is formed on the hinge portion, and
wherein the hinge support comprises a rib that is inserted into the rib groove to restrict movement, along a direction of the hinge axis, of the hinge portion.

11. The vehicle of claim 10, wherein the hinge support further comprises a pair of support walls that rotatably support both sides of the hinge portion, and
wherein the rib is positioned by being biased toward one support wall of the pair of support walls.

12. The vehicle of claim 10, wherein the hinge portion comprises:
two first diameter portions, and
a second diameter portion that is disposed between the two first diameter portions,
wherein a first diameter of the two first diameter portions is greater than a second diameter of the second diameter portion, and
wherein the rib groove is defined by an outer surface of the second diameter portion in a space between the two first diameter portions.

13. The vehicle of claim 12, wherein the hinge support comprises a pair of support walls to which the hinge portion is connected,
wherein movement, along the direction of the hinge axis, of a first one, of the two first diameter portions, is restricted between a first support wall, of the pair of support walls, and the rib, and
wherein movement, along the direction of the hinge axis, of a second one, of the two first diameter portions, is restricted between a second support wall, of the pair of support walls, and the rib.

14. The vehicle of claim 10, wherein the hinge portion comprises:
a bushing through which a hinge pin penetrates, and
a spring configured to provide an elastic resilience to restore the one or more covers from the closed state to an open state.

15. The vehicle of claim 10, wherein the one or more latches are connected, via a second hinge, to the attachment bracket and comprises a release portion, and
wherein the vehicle further comprises an actuator configured to release the one or more latches by pushing the release portion, of the one or more latches, to rotate the one or more latches around the second hinge.

16. The vehicle of claim 15, further comprising:
a sensor configured to detect a charging plug; and
a controller configured to control, based on the charging plug being detected by the sensor, the actuator.

17. The vehicle of claim 15, further comprising:
a rain sensor; and
a controller configured to control, based on a signal from the rain sensor, the actuator.

18. The vehicle of claim 10, wherein the one or more charging ports comprise a first charging port and a second charging port,
wherein the one or more latches comprise a first latch and a second latch, and
wherein the one or more covers comprise:
a first cover configured to cover or uncover the first charging port, wherein the first latch is configured to hold the first cover in the closed state, and
a second cover configured to cover or uncover the second charging port, wherein the second latch is configured to hold the second cover in the closed state, and
wherein the first cover and the second cover at least partially overlap along the direction of the hinge axis.

19. The vehicle of claim 18, wherein the first cover comprises:
a flange, and
a cover rib extending from the flange along a second direction perpendicular to the direction of the hinge axis, and
wherein the second cover comprises:
a first recess configured to be covered by the flange, and
a second recess configured to face the cover rib in the second direction.

20. The vehicle of claim 18, wherein the attachment bracket comprises:
a first port groove in which the first charging port is placed,
a second port groove in which the second charging port is placed, and
a latch groove configured to receive a latch of a charging connector, wherein the latch groove comprises a flat surface comprising a peripheral perimeter region of the first port groove, a peripheral perimeter region of the second port groove, and a peripheral perimeter region of the latch groove,
wherein the first cover comprises a first pad configured to abut the peripheral perimeter region of the first port groove and the peripheral perimeter region of the latch groove, and
wherein the second cover comprises a second pad configured to abut the peripheral perimeter region of the second port groove.
